(19) United States
(12) Patent Application Publication
(10) Pub. No.: US 2012/0272624 A1
(43) Pub. Date: Nov. 1, 2012

(54) SEMI-AUTOMATED CAP SECURING APPARATUS

(75) Inventors: James ARGERIOU, Candia, NH (US); Lawrence J. QUINLAN, Amherst, NH (US)

(73) Assignee: KINEX CAPPERS LLC, Amherst, NH (US)

(21) Appl. No.: 13/457,806

(22) Filed: Apr. 27, 2012

Related U.S. Application Data
(60) Provisional application No. 61/480,576, filed on Apr. 29, 2011.

(51) Int. Cl. B67B 3/20

(52) U.S. Cl. 53/490; 53/285

(57) ABSTRACT

A cap securing apparatus for rotating a cap relative to a container. The cap securing apparatus comprises a support base supporting a main support, the main support supporting a plurality of arms, and each of the plurality of arms supporting a rotatable wheel adjacent a remote free end thereof. A drive mechanism supplies drive to at least one of the rotatable wheels, supported by the plurality of arms, for inducing rotation thereof. A cap engagement mechanism moves the wheels from a disengaged first position, in which the wheels are spaced from the cap to be one of capped or uncapped with respect to the container, into an engaged second position in which the wheels engage with the cap for inducing rotation of the cap and one of capping the cap to the container and uncapping the cap from the container.

### FIELD OF THE INVENTION

The present invention relates to a pump, a collar, a cover or a cap securing apparatus for easily, consistently and reliably capping/uncapping a desired pump, collar, cover or cap (all of which are hereinafter collectively referred to as a “cap”) to the threaded opening of a desired container.

### BACKGROUND OF THE INVENTION

A variety of mechanized devices are currently available in the prior art for rapid torquing and securing or untorquing and unsecuring a threaded cap to or from a threaded opening of a container. One such device generally comprises a single rotatable head with an internal cavity which receives, surrounds and frictionally engages with the cap, via an axially downward directed motion of the head from above the cap. Once the rotatable head sufficiently frictionally engages with the cap, the rotatable head is then activated to apply sufficient torque to rotate the cap, relative to the container, and sufficiently cap or uncap the cap to the container in a conventional manner.

One drawback with such mechanized devices is that the rotatable head must have an unobstructed axial path from vertically above the cap, so as to permit the rotatable head to receive and engage with the top and/or sides of the cap so as to permit inducing relative rotation thereto. However, when the cap includes an additional component(s) or feature(s), such as a pump head, a spray head, an irregular shaped top portion, etc., then an unobstructed axial path is not present for securing/unsecuring such cap and thus the currently available mechanized devices cannot be used for easily, consistently and reliably securing/unsecuring the caps to or from the containers.

### SUMMARY OF THE INVENTION

Wherefore, it is an object of the present invention to overcome the above mentioned shortcomings and drawbacks associated with the prior art mechanized securing devices.

Another object of the present invention is to provide a cap securing apparatus which facilitates easy, quick, reliable and accurate securing or unsecuring of a cap to the threaded opening of a container, by moving a plurality of rotatable wheels laterally or radially inward toward a portion of a centrally located cap so that the rotatable wheels can frictionally engage with a lateral surface of the cap and induce a desired rotation, i.e., tightening or untightening, of the cap which sufficiently rotates the cap relative to the threaded opening of the container.

A further object of the present invention is to provide substantially simultaneously activated drive mechanism and a cap engagement mechanism which cooperate with one another for securing/unsecuring the cap with the threaded opening of the container and, once this is achieved, the cap engagement mechanism facilitates movement of the rotatable wheels, from contact with the lateral surface of the cap, so that the container can be removed and replaced with a new container having a new cap to be either secured thereto or removed therefrom.

Yet another object of the present invention is to provide a pressurized air or fluid actuator, which is preferably pneumatically or hydraulically actuated, that is arranged to actuate simultaneously at least one (1), more preferably at least two (2) and most preferably three (3) or four (4), movable or pivotally mounted (pivotable) arms, which are each coupled with a vertically movable constrictor plate that controls movement of the pivotable arms and thereby facilitates both engagement of the rotatable wheels, accommodated at a remote free end of each of the pivotable arms, with the cap to be secured/unsecured, as well as disengagement and release of the rotatable wheels, supported by the remote free end of each of the pivotable arms, from the secured/unsecured cap once the cap is sufficiently rotated, relative to the container, by the cap securing apparatus.

A still further object of the present invention is to mount each one of the pivotable arms so that they are each rotatably driven so as to drive the wheel, supported at the free end thereof, in a desired rotational direction for securing/unsecuring a cap with a container. Preferably a slave pulley is supported adjacent the pivotally attached end of each of the movable or pivotable arms and driven by a master pulley supported by a drive shaft of a motor. The master pulley is coupled to each one of the slave pulleys, via a flexible drive belt, for simultaneously driving the wheels supported by each one of the movable or pivotable arms.

A still further additional object of the present invention is to provide a cap securing apparatus in which the rotatable wheel, accommodated by the free end of each one of the movable or pivotable arms, can be readily replaced as necessary or desired so as to facilitate the cap securing apparatus properly engaging with the desired cap to be secured to a desired container.

It is to be appreciated that there are several ways to approach the problem of accurately and repeatably securing or unsecuring caps of various shapes and sizes with respect to containers of various shapes and sizes. A standard line of cap tightening products may excel at torquing/untorquing the caps with the containers, but they will be limited to simple shaped caps and will typically not work with caps which include a nozzle, a spray head, a pump spout, a pump dispenser or any other protruding feature of cap, for example. The cap securing apparatus, according to the present invention, provides an arrangement in which the movable or pivotable arms move essentially radially inwardly toward a cap to be capped/uncapped, but are sufficiently spaced from the cap so as to provide a vertical area above the rotatable wheels which is not breached or entered into by any component(s) or element(s) of the cap securing apparatus.

The invention further relates to a cap securing apparatus for rotating a cap relative to a container, the cap securing apparatus comprising: a support base supporting a main support; the main support supporting a plurality of arms, and each of the plurality of arms supporting a rotatable wheel adjacent a remote free end thereof; a drive mechanism for supplying drive to at least one of the rotatable wheels, supported by the plurality of arms, for inducing rotation thereof; a cap engagement mechanism for moving the wheels from a disengaged first position, in which the wheels are spaced from the cap to be one of capped or uncapped with respect to the container, into an engaged second position in which the wheels engage with the cap for inducing rotation of the cap and one of capping the cap to the container and uncapping the cap from the container.

The invention also relates to a method of rotating a cap with respect to a container via a cap securing apparatus for rotating a cap relative to a container, the cap securing apparatus comprising a support base supporting a main support, the main support supporting a plurality of arms, and each of the plurality of arms supporting a rotatable wheel adjacent a remote free end thereof, a drive mechanism for supplying drive to at least one of the rotatable wheels, supported by the plurality of arms, for inducing rotation thereof, a cap engagement mechanism for moving the wheels from a disengaged first position, in which the wheels are spaced from the cap to be one of capped or uncapped with respect to the container, into an engaged second position in which the wheels engage with the cap for inducing rotation of the cap and one of capping the cap to the container and uncapping the cap from the container, the method comprising the steps of: placing the container with the cap to be one of capped to or uncapped from the container on the support base; actuating the drive mechanism to supply drive to at least one of the rotatable wheels an actuation device; actuating the cap engagement mechanism to move the wheels from the disengaged first position into the engaged second position to engage and induce rotation of the cap and one of capping the cap to the container and uncapping the cap from the container; and deactuating both the drive mechanism and the cap engagement mechanism.

### BRIEF DESCRIPTION OF THE DRAWINGS

The invention will now be described, by way of example, with reference to the accompanying drawings in which:

FIG. 1 is a top, front elevation view of a cap securing apparatus according to the present invention;

FIG. 1A is a diagrammatic top, front, right side perspective view of support base supporting a V-block and a pair of lateral guides;

FIG. 1B is a diagrammatic top, front, left side perspective view of the V-block and the pair of lateral guides prior to installation on the support base;

FIG. 2 is a top, front, right side perspective view of the cap securing apparatus in FIG. 1;

FIG. 3 is top, front, right side partially exploded diagrammatic representation of the cap securing apparatus in FIG. 1;

FIG. 4A is a diagrammatic exploded view of a movable or pivotable arm;

FIG. 4B is a diagrammatic assembled front view of a movable or pivotable arm;

FIG. 4C is a diagrammatic assembled rear view of the movable or pivotable arm of the cap securing apparatus showing the slave pulley affixed thereto;

FIG. 4D is an enlarged diagrammatic cross sectional view showing details of a releasable lock for securing the wheel to the free end of the movable or pivotable arm;

FIGS. 5A and 5B respectively are an exploded view and an assembled side elevation view of the constrictor plate of the cap securing apparatus in FIG. 1;

FIG. 6 is a top, front elevation view of a cap securing apparatus according to the present invention with the housing eliminated so as to show additional details;

FIG. 7 is a bottom, front right side elevation view of a cap securing apparatus according to the present invention with the housing eliminated so as to show additional details;

FIG. 8 is a bottom, rear, side elevation view of a cap securing apparatus according to the present invention with the housing and other components eliminated so as to show additional details;

FIG. 9 is a diagrammatic top perspective view, without the housing, to show the belt drive assembly;

FIGS. 10A, 10B, 10C, 10D and 10E are respectively a front elevational view, a right side elevational view, a top plan view, a top, front, right side perspective view and a diagrammatic cross sectional right side view of the cap securing apparatus of FIG. 1 shown in the disengaged first position, with the support base, housing and adjustment components eliminated for clarity;

FIGS. 11A, 11B, 11C, 11D and 11E are respectively a front elevational view, a right side elevational view, a top plan view, a top, front, right side perspective view and a diagrammatic cross sectional right side view of the cap securing apparatus of FIG. 1 shown in an intermediate position, with the support base, housing and adjustment components eliminated for clarity;

FIGS. 12A, 12B, 12C and 12D are respectively a front elevational view, a right side elevational view, a top plan view, a top, front, right side perspective view and a diagrammatic cross sectional right side view of the cap securing apparatus of FIG. 1 shown in the engaged second position, with the support base, housing and adjustment components eliminated for clarity;

FIG. 13 is a table showing typical clamping forces to be provided by the wheels against the cap to be capped/uncapped, depending upon the supply pressure of the compressed air or fluid;

FIG. 14 is a diagram drawing of a pressured or a compressed air or fluid circuit for controlling operation of the cap securing apparatus; and

FIG. 15 is a diagram partial cross sectional drawing of the air motor of the cap securing apparatus.

### DETAILED DESCRIPTION OF THE INVENTION

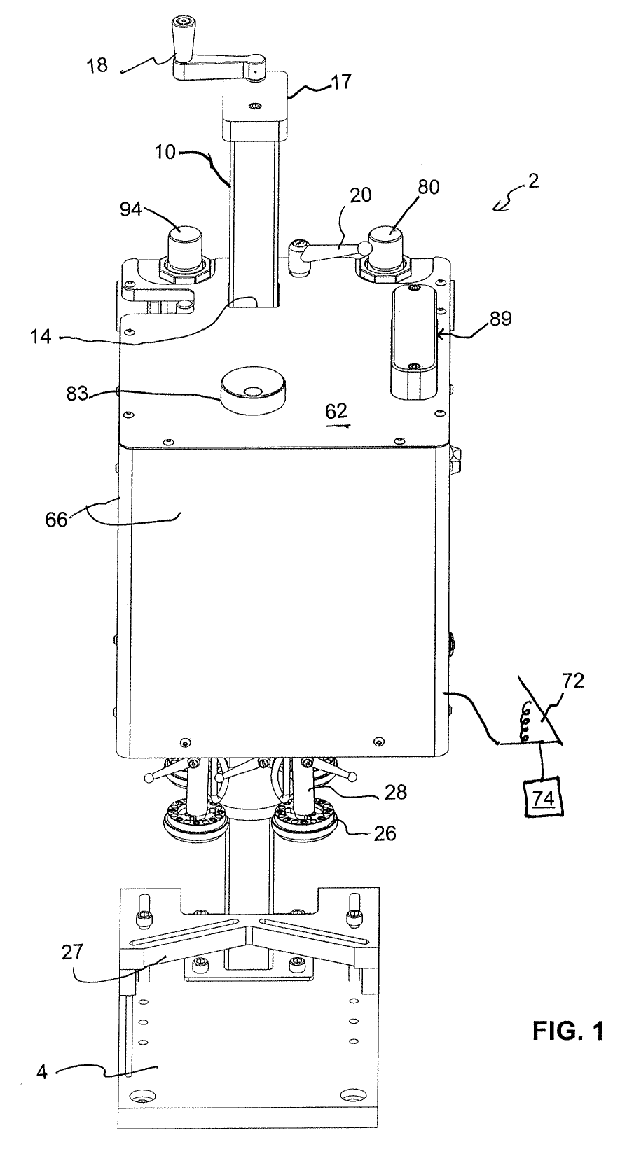

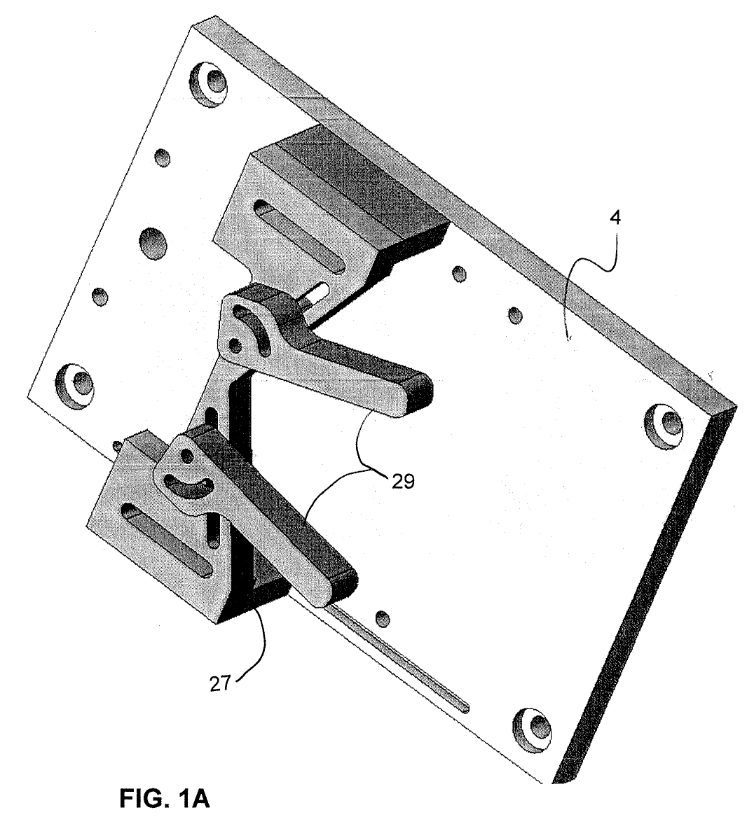

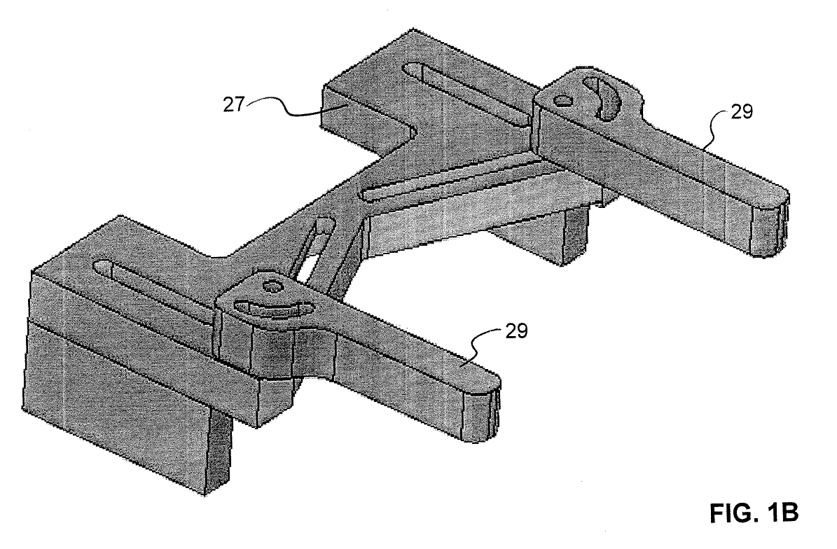

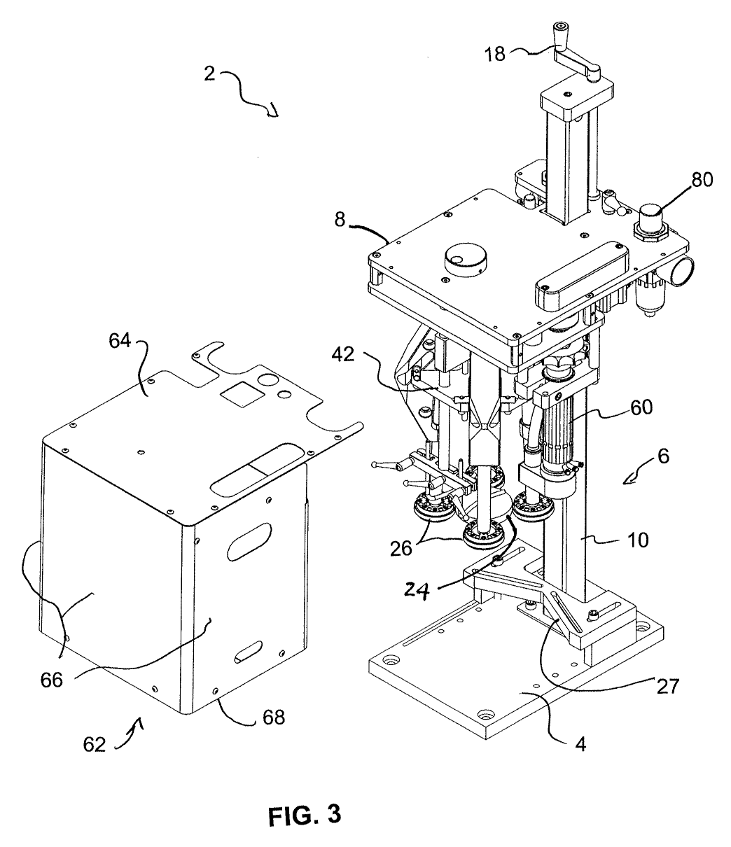

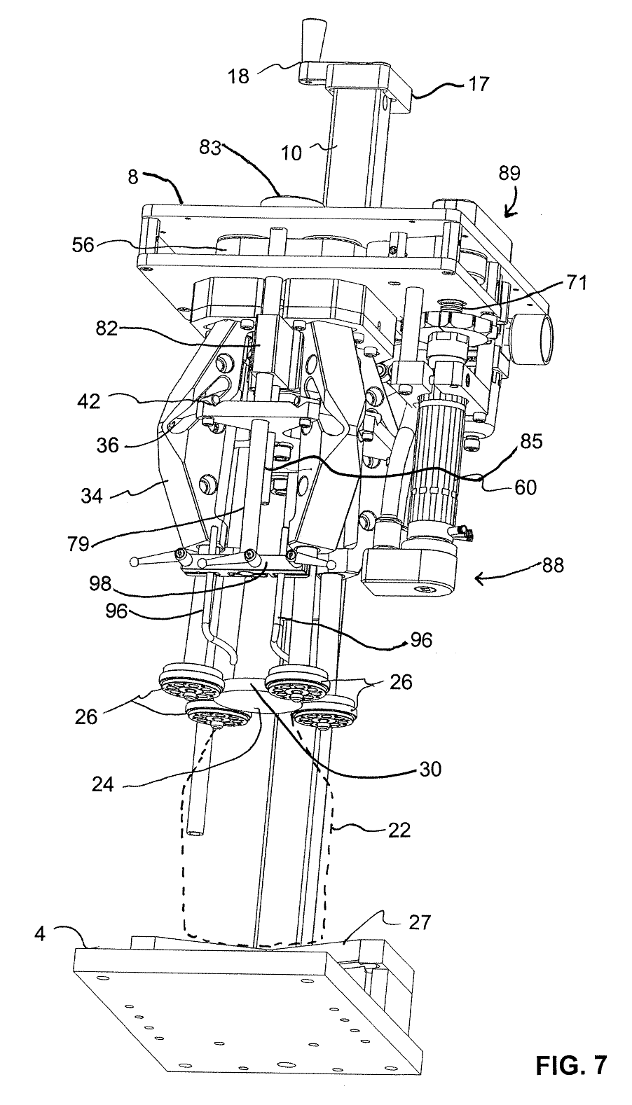

With reference now to FIGS. 1-3 of the drawings, a detail description concerning the various components of the cap securing apparatus, according to the present invention, will now be briefly discussed. As can be seen generally in those Figures, for example, the cap securing apparatus 2 generally comprises a support base 4 for supporting the cap securing apparatus 2 on a desired surface, for example, such as a table, an assembly platform or a workbench. A top surface of the support base 4 also supports a desired container 22 (see FIG. 7, for example) to be capped/uncapped, which will be discussed below in further detail. A first end of a post assembly 6 is permanently secured to the support base 4 while an adjustable main support 8 (see FIG. 3, for example), of the cap securing apparatus 2, is adjustably supported by and movable along the post-assembly 6 so as to facilitate adjustment of the relative spacing between the main support 8 and the support base 4.

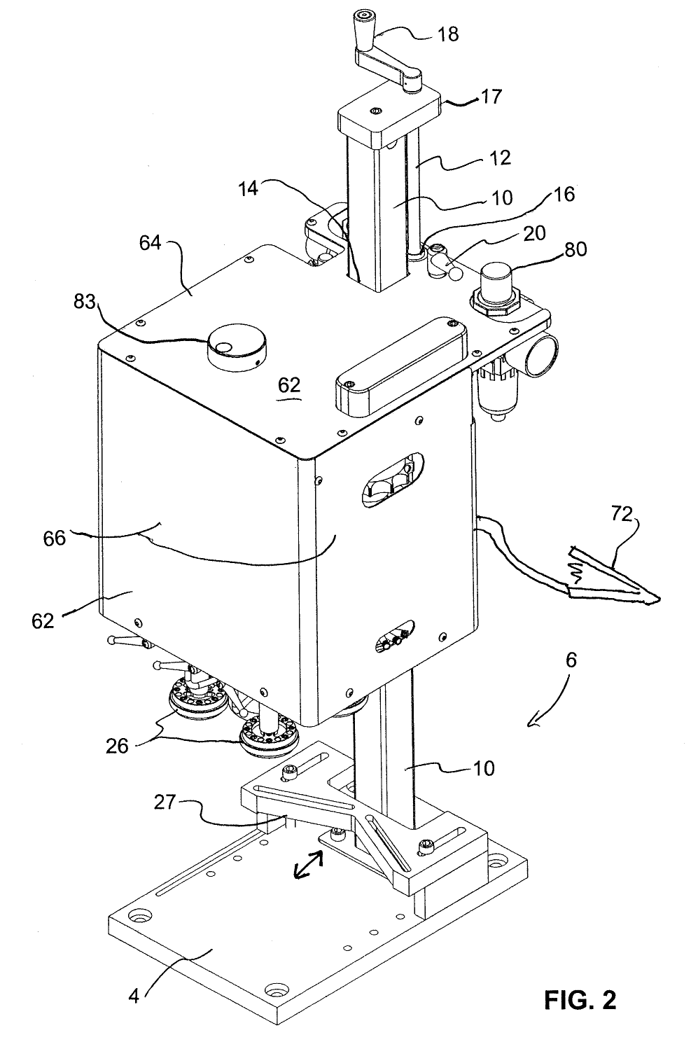

The post-assembly 6 generally comprises both a guidepost 10 and a lead screw 12 (see FIG. 2 for example) which are both located closely adjacent to and extend generally parallel to one another. At least one end of the guidepost 10 is permanently connected to the support base 4. A guide and slide section 14 of the main support 8 surrounds and intimately engages with the guidepost 10 so as to prevent rotation of the main support 8 and facilitate low friction sliding and guiding movement of the main support 8 along and relative to the guidepost 10. The main support 8 also has a threaded through hole 16 which matingly engages with the exterior thread of the lead screw 12 to facilitate threaded vertical adjustment of the main support 8, along the guidepost 10, relative to the support base 4.

A post-assembly plate 17 is fixedly connected to the uppermost portion of a second end of the guidepost 10. An elevation lead screw crank 18 is secured to the vertically uppermost free end of the lead screw 12 to facilitate desired manual rotation of the lead screw 12, in a desired rotational direction, by an operator. One or more bearings or other elements (not shown in detail) couple both the lead screw 12 and the screw crank 18 to the post-assembly plate 17 so as to facilitate rotation thereof relative to the post-assembly plate 17. As a result of this arrangement, any rotation of the lead screw 12, in either a clockwise or a counter clockwise rotational direction, via manual rotation of the screw crank 18, causes the main support 8 to be conveyed either vertically upward toward the post-assembly plate 17 and away from the support base 4 or vertically downward away from post-assembly plate 17 and toward the support base 4 and thereby provide the desired adjustment of the main support 8, the purpose of which will be come apparent from the following description. The guide and slide section 14 of the main support 8 typically has conventional bearing members and/or some other low friction surface slide and/or guide surface(s) or member(s) (not shown in detail) which engage with the guidepost 10 and facilitate the desired low friction guiding and sliding motion of the main support 8 along and relative to the guidepost 10 when the elevation lead screw crank 18 is rotated in either a clockwise or a counter clockwise direction.

The lead screw 12 may be, for example, a 3/8 inch diameter right hand acme screw thread with an 8 pitch and a 4 start, such that the main support 8 moves vertically 0.125 inches of travel for each revolution of the lead screw 12. It is to be appreciated that other diameter and/or pitch lead screws would also be suitable for adjusting the position of the main support 8 relative to the support base 4.

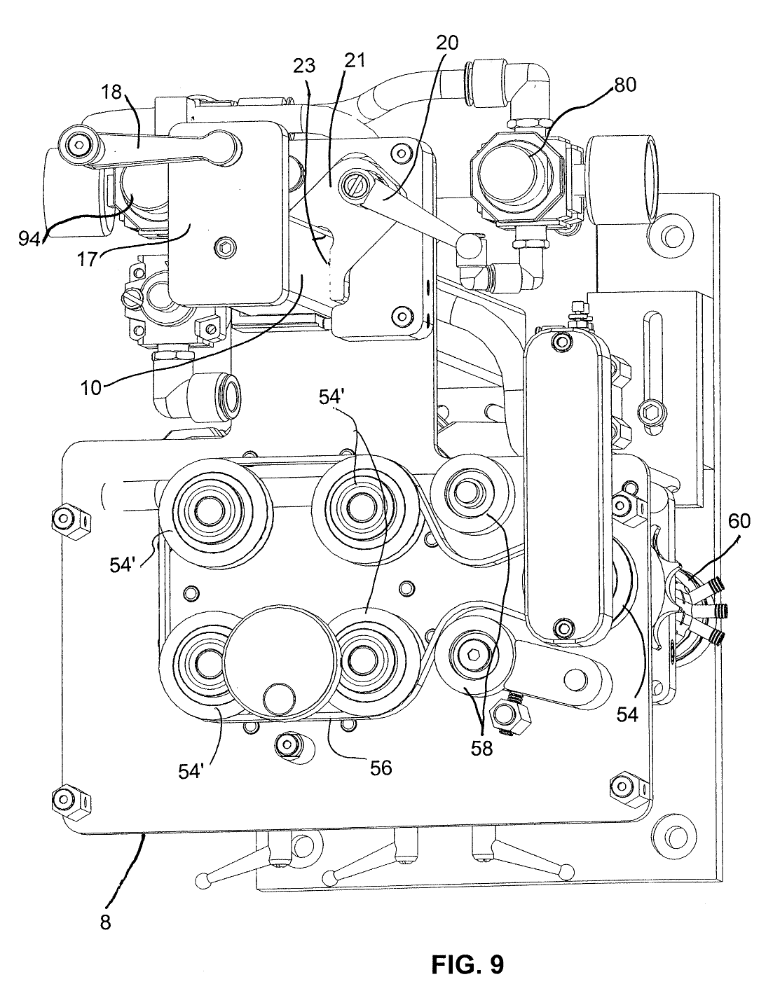

The cap securing apparatus 2 also includes a locking mechanism in the form of a rotatable post clamp 20 (see FIGS. 1, 2 and 9, for example), for reliably securing and retaining the adjusted vertical position of the main support 8 along the post-assembly 6, following desired adjustment thereof. The post clamp 20 includes a coupled clamping member 21 having a pair of L-shaped guidepost engaging surfaces 23 which are designed and configured to abut against two adjacent sidewall surfaces of the guidepost 10, in a clamping first position, and frictionally prevent any relative movement therebetween, while when the clamping member 21 is in a spaced second position, the pair of L-shaped guide post engaging surfaces 23 of the clamping member 21 are sufficiently spaced away from the two adjacent sidewall surfaces of the guidepost 10 so as to permit desired relative movement between the guidepost 10 and the clamping member 21. A lower portion of the rotatable post clamp 20 has an integral cam member (not separately labeled) which is received within an aperture (not separately labeled) of the clamping member 21 for coupling the clamping member 21 to the post clamp 20. As such, rotation of the post clamp 20 thus correspondingly rotates the integral cam member which, in turn, cooperates with the aperture of the clamping member 21 and thereby causes the clamping member 21 to move into its first clamping position such that the pair of L-shaped guide post engaging surfaces 23 engage and abut against the two adjacent sidewall surfaces of the guidepost 10 and thereby frictionally prevent relative movement therebetween. When the post clamp 20 is moved into its spaced second position, relative movement between the guidepost 10 and the clamping member 21 is thus permitted. According to one embodiment of the present invention, the post clamp 20 is supported by the main support 8 closely adjacent the guidepost 10, as shown in FIG. 9.

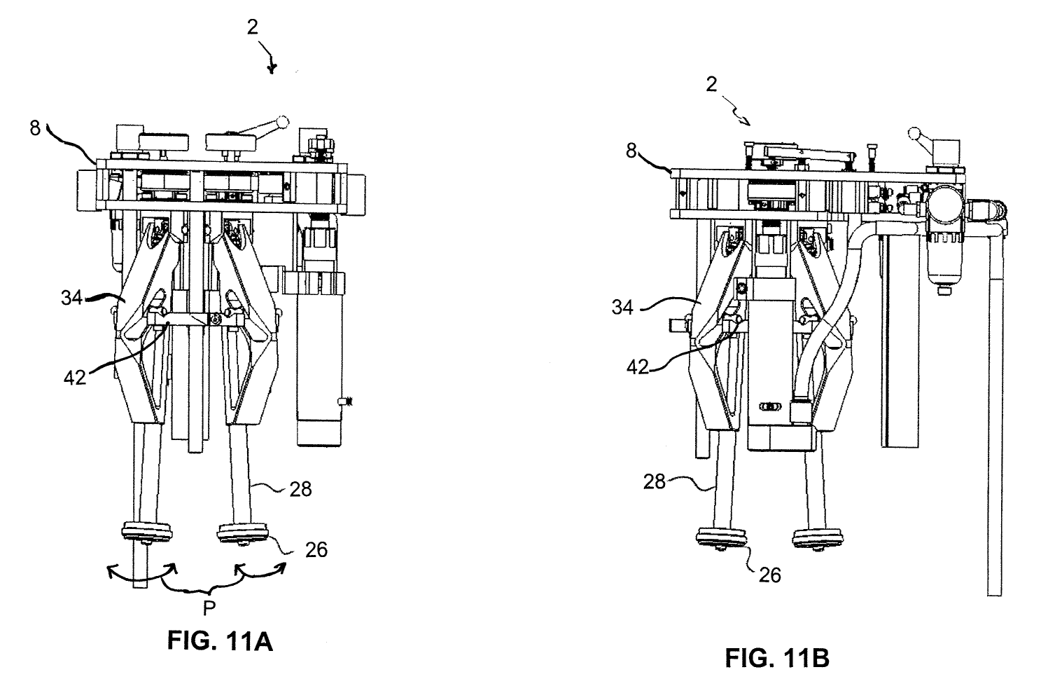

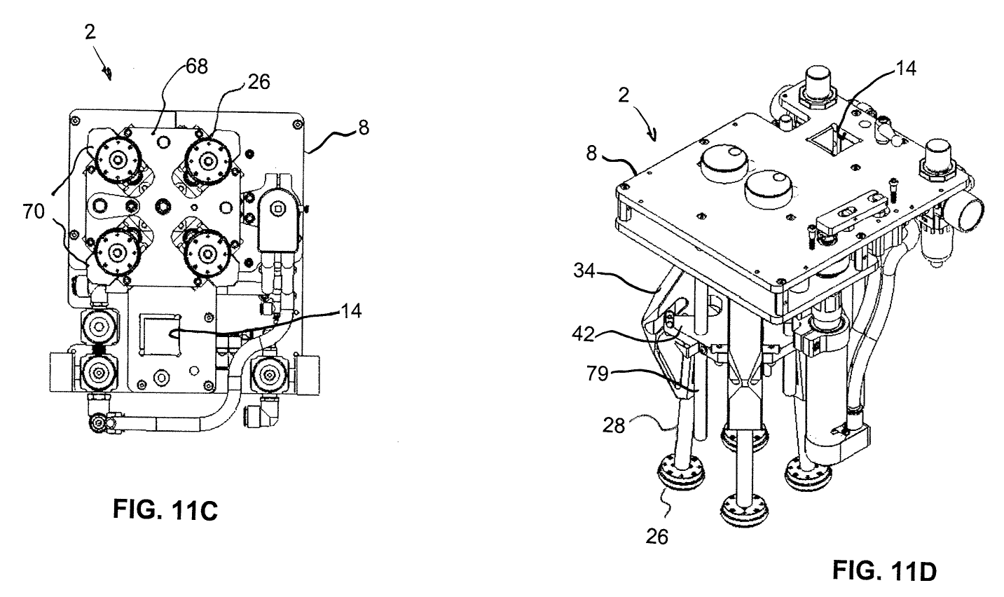

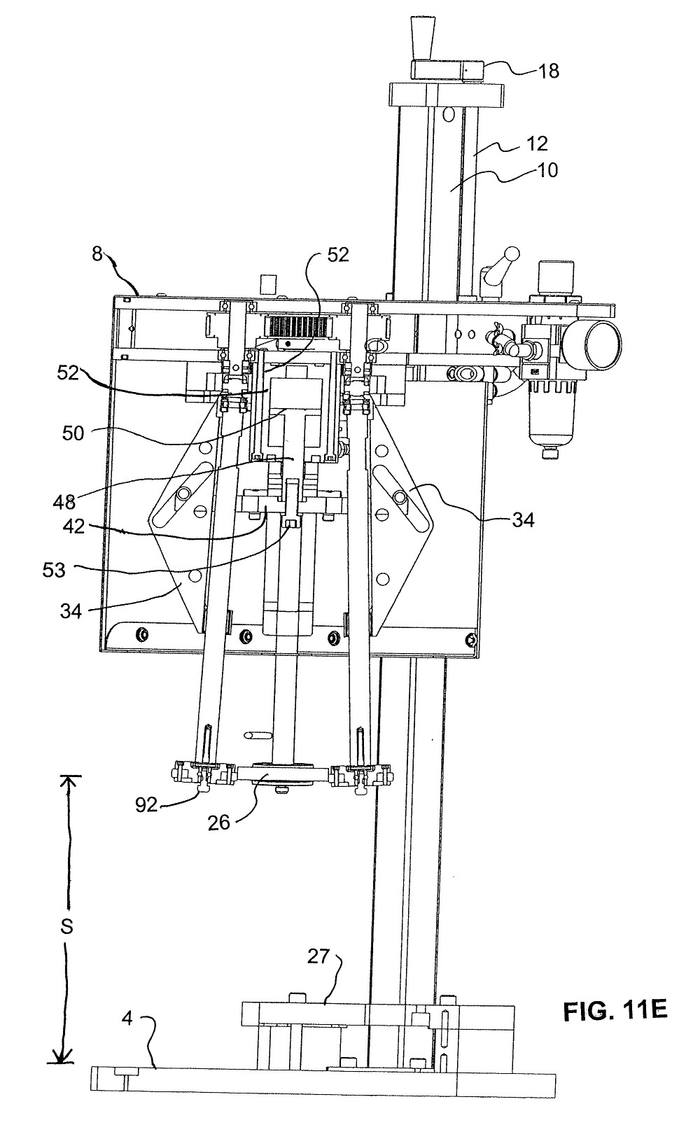

When desired, the position of the main support 8, relative to the support base 4, can be easily adjusted by loosening the post clamp 20, i.e., moving the post clamp 20 to its spaced second position, and rotating the elevation lead screw crank 18 in a desired rotational direction, i.e., either clockwise or counterclockwise. Such rotation either increases or decreases the relative spacing between the main support 8 and the post-assembly plate 17 as well as the spacing between a lower surface of the main support 8 and the top surface of the support base 4, to facilitating raising or lowering the main support 8 and thereby accommodating different height and/or sized containers on the support base 4. Once the desired relative spacing is achieved by the operator, e.g., relative spacing S is achieved, as shown in FIG. 11E, which corresponds to the height of a desired container 22 to be accommodated, for example, then the post clamp 20 is again re-tightened in order to lock the desired adjusted position of the main support 8, along the guidepost 10, relative to the support base 4.

It is to be appreciated that the main support 8 is typically readjusted each time a different size and/or height container 22, with an associated cap 24 to be capped/uncapped thereto, is to be placed on the support base 4 for capping/uncapping the cap 24 (see FIG. 7, for example). Each desired adjustment of the cap securing apparatus 2 will suitably reposition the rotatable wheels 26, supported at a vertically lower most end of each of the movable or pivotable arms 28, so that they precisely engage with an intermediate lateral surface 30 of the cap 24 to be capped or secured in order to induce a desired relative securing rotation of the cap 24, e.g., typically in a clockwise direction, with respect to the container 22, or induce a desired relative uncapping rotation of the cap 24, e.g., typically in a counter clockwise direction, with respect to the container 22, which will be described below in further detail.

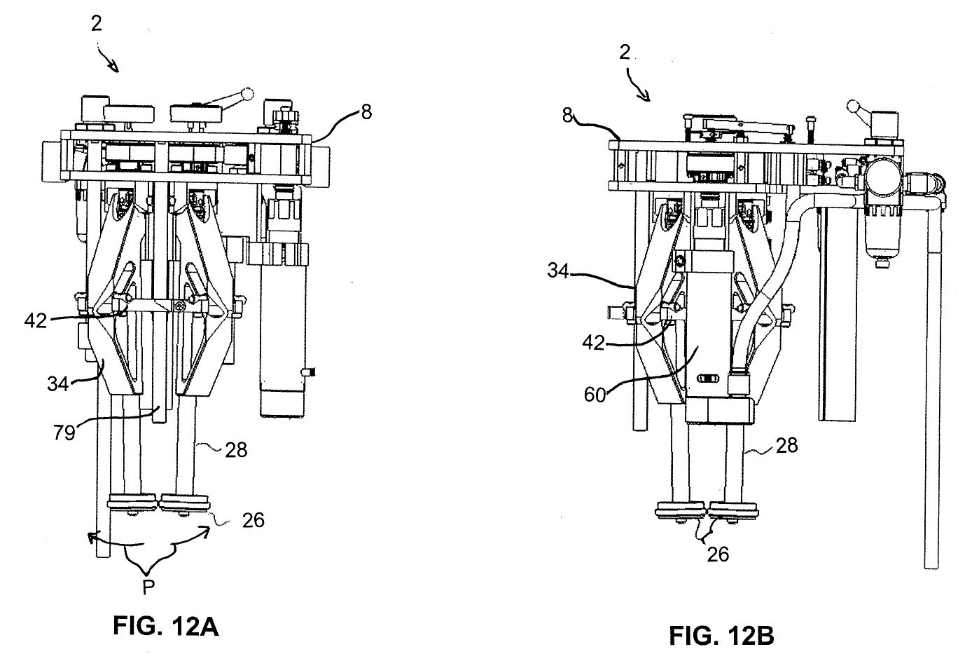

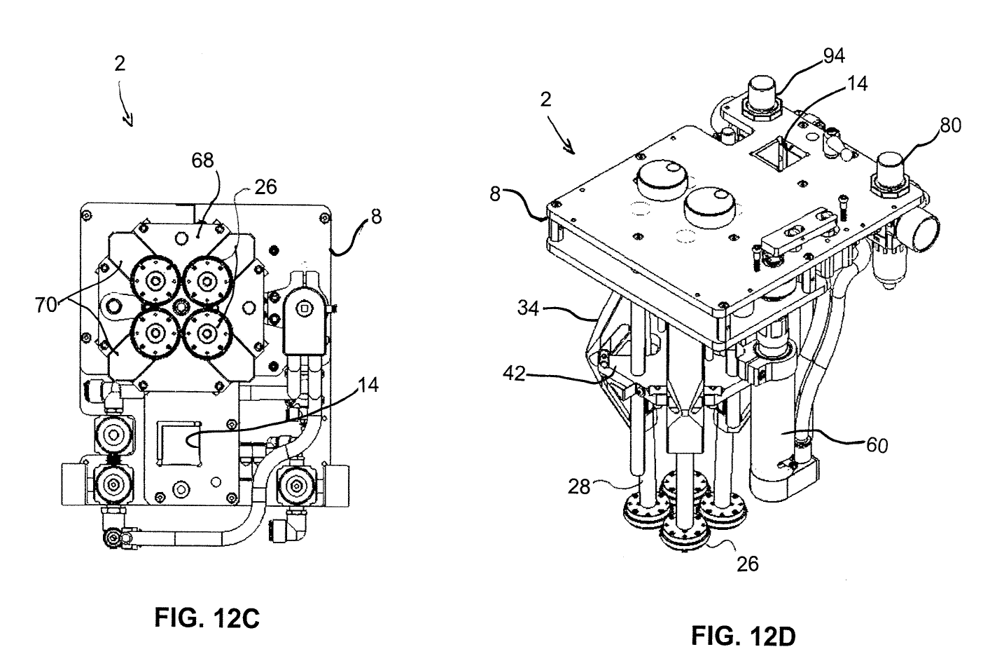

As generally shown in FIGS. 1A and 1B, for example, the top surface of the support base 4 also supports an adjustable V-block 27 which is provided in order to assist with uniform and consistent positioning of the container 22 relative to the support base 4. The V-block 27 is adjustably attached to the top surface of the support base 4 via at least one elongate slot (not labeled) formed in the support base 4 and coupling elements (not shown), such as nuts and bolts, etc., to permit desired adjustment of the location/spacing of the V-block 27 relative to the post-assembly 6. The V-block has a plurality of adjustment slots (not shown) which adjustably support a pair of lateral guides 29. By conventional adjustment of the location of the pair of lateral guides 29, the operator can readily adjust to the width of the receiving area for repeatedly accommodating the desired container 22 therebetween and thereby prevent relative rotation of the container 22 with respect to the support base 4 during operation. That is, as the container 22 is brought into engagement with the support base 4, the V-block 27 and the pair of spaced apart lateral guides 29 help locate, position and center the container 22 for intimate engagement with the wheels 26 once the pivotable arms 28 are brought into their engaged second position, as shown in FIGS. 12A-12E, and avoid rotation of the container 22.

If so desired, a conventional vice or some other conventional clamping mechanism or member may be utilized alone, or in combination with the V-block 27 and/or the lateral guides 29, in order to assist with securely clamping and restraining the container 22 on the support base 4 during either capping or uncapping of the cap 24 with respect to the container 22. It is to be appreciated that when the container 22 is either quite small or the operator desires to keep his/her hands sufficiently away from the cap securing apparatus 2 during the capping/uncapping operation, typically a vice or some other clamping mechanism will be utilized.

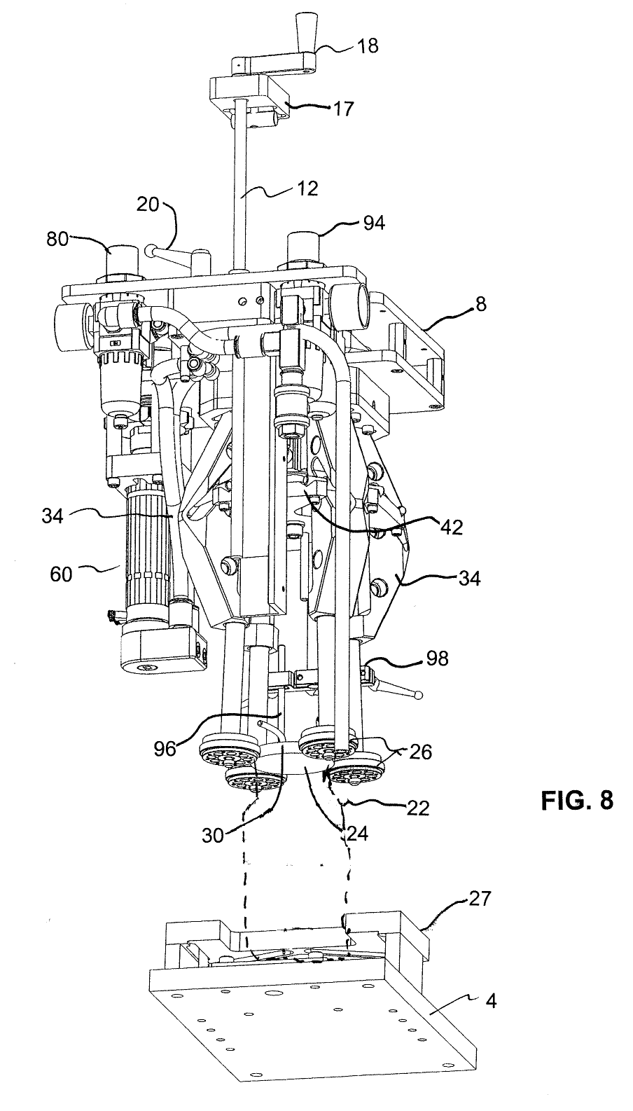

With reference now to FIGS. 2, 3, 4A, 4B, 4C, 6, 7 and 8, further details concerning additional elements of the cap securing apparatus 2 will now be described. As shown in FIGS. 2 and 3, the cap securing apparatus 2 generally includes four (4) convergable and pivotable arms 28 which are each pivotably supported, via a respective main pivot 32, to the main support 8 of the cap securing apparatus 2 to facilitate pivoting movement of the pivotable arms 28 relative to the main support 8. It is to be appreciated that more or less pivotable arms 28 may be utilized, depending upon the particular application, but typically three or four pivotable arms 28 will be sufficient for most applications.

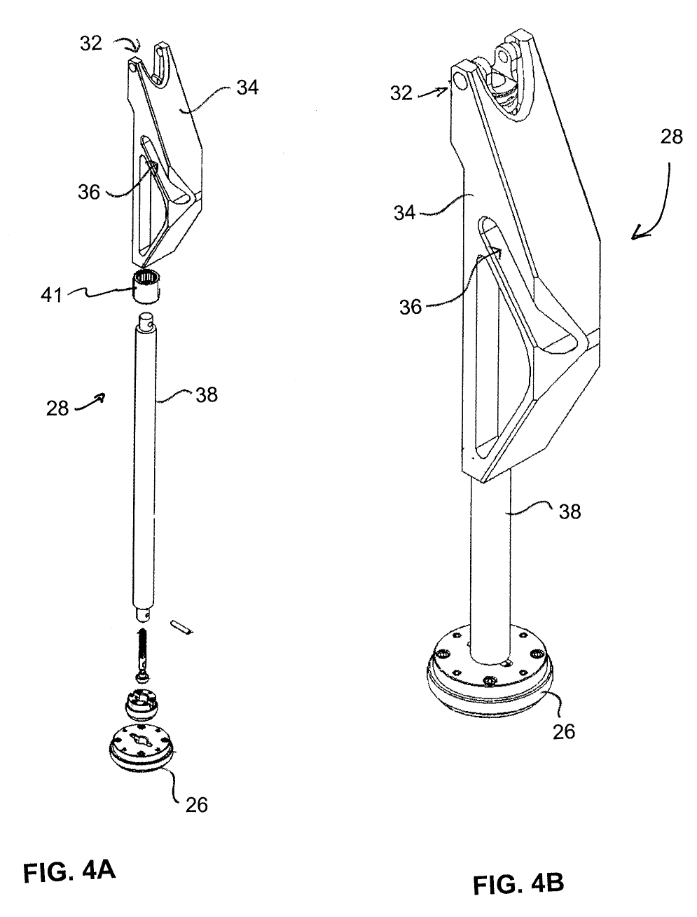

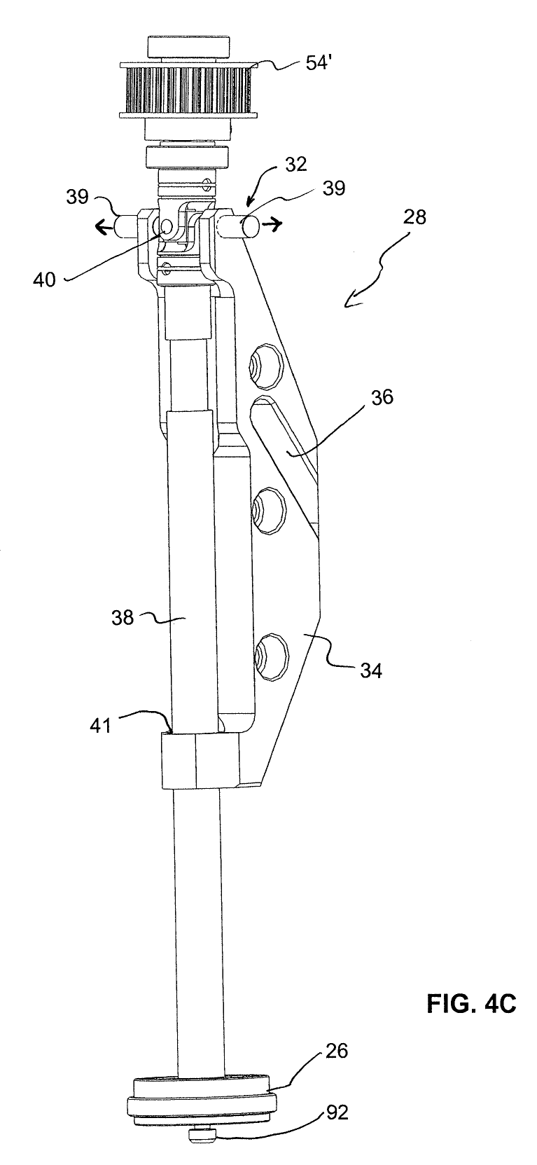

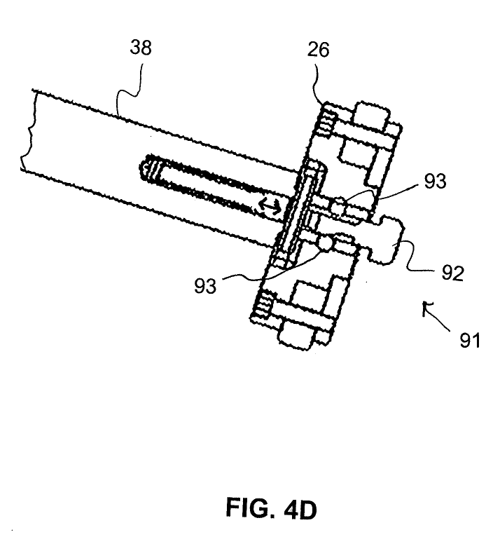

Each one of the pivotable arms 28 comprises a generally triangular shaped guide assembly 34 (see FIGS. 4A, 4B and 4C) and an integrated rotatable drive shaft 38. A vertically upper most end of the guide assembly 34 includes a pair of outwardly extending opposed pins 39 (see FIG. 4C) which matingly engage with a pair of mating recesses (not labeled), of the main support 8, to form the main pivot 32 and thereby facilitate the desired pivoting movement of the guide assembly 34 with respect to the main support 8, the purpose of such pivoting movement will become apparent from the following description. Each guide assembly 34 also includes an elongate inclined slot 36 formed therein which assists with controlling movement of the guide assembly 34 and thus, in turn, the rotatable drive shaft 38, as will be discussed below in further detail.

A vertically lower most end of each guide assembly 34 has a cylindrical sleeve 41 which receives, surrounds and accommodates an intermediate portion of the rotatable drive shaft 38 to facilitate rotational retention thereof. One or more internal bearings, or some other low friction element (not shown in detail), is typically accommodated within and/or lines an inwardly facing surface of the cylindrical sleeve 41 of the guide assembly 34 to facilitate rotation of the drive shaft 38 relative thereto. It is to be appreciated that a variety of other conventional bearings, e.g., needle bearings, or other low friction elements or members may be utilized in order to facilitate rotation of the drive shaft 38 relative to the cylindrical sleeve 41 of the guide assembly 34 without causing any excessive drag or friction therebetween.

A rotatable wheel 26 is releasably coupled to a vertically lower most first end of each drive shaft 38 while an opposite second end of each drive shaft 38 extends and passes through the cylindrical sleeve 41 of the guide assembly 34 and is connected with a first portion of a drive shaft pivot 40, such as a constant velocity knuckle or other pivotable joint, which facilitates transfer of rotational drive as well as assists with permitting the desired movement or pivoting motion of the drive shaft 38 relative to the main support 8. As a result of such arrangement, any movement of the guide assembly 34 is correspondingly transferred and conveyed, by the cylindrical sleeve 41 of the guide assembly 34, directly to the drive shaft 38 while the drive shaft 38 and the rotatable wheel 26 are still permitted to rotate relative to the guide assembly 34.

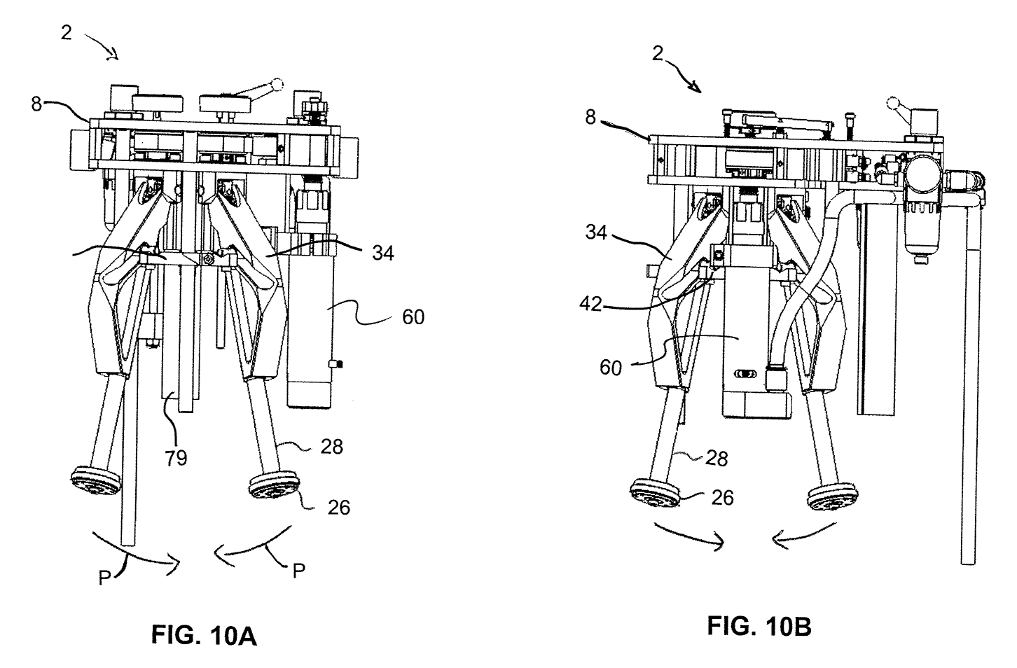

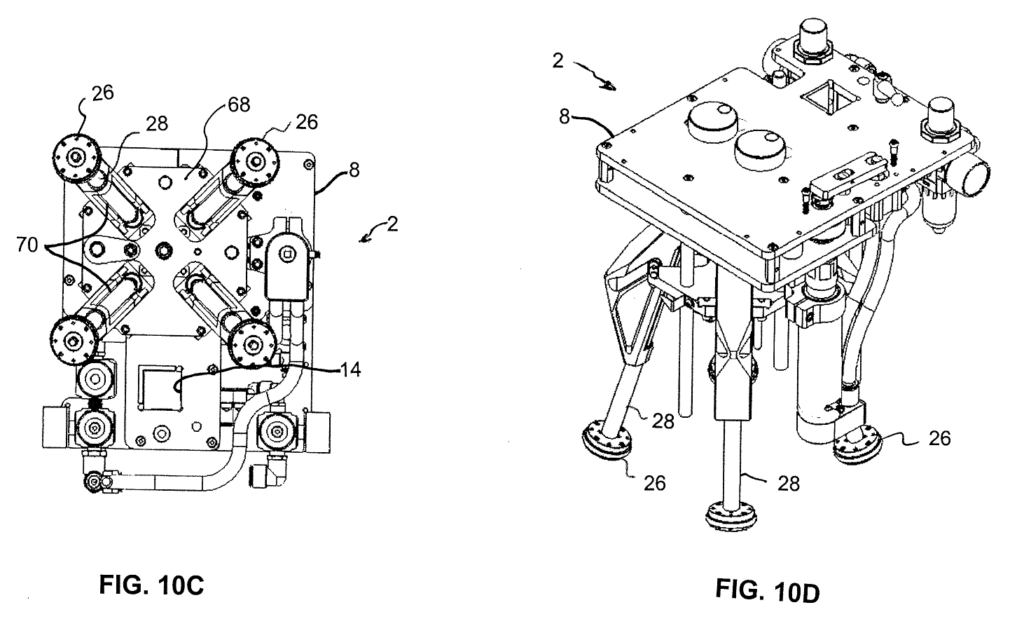

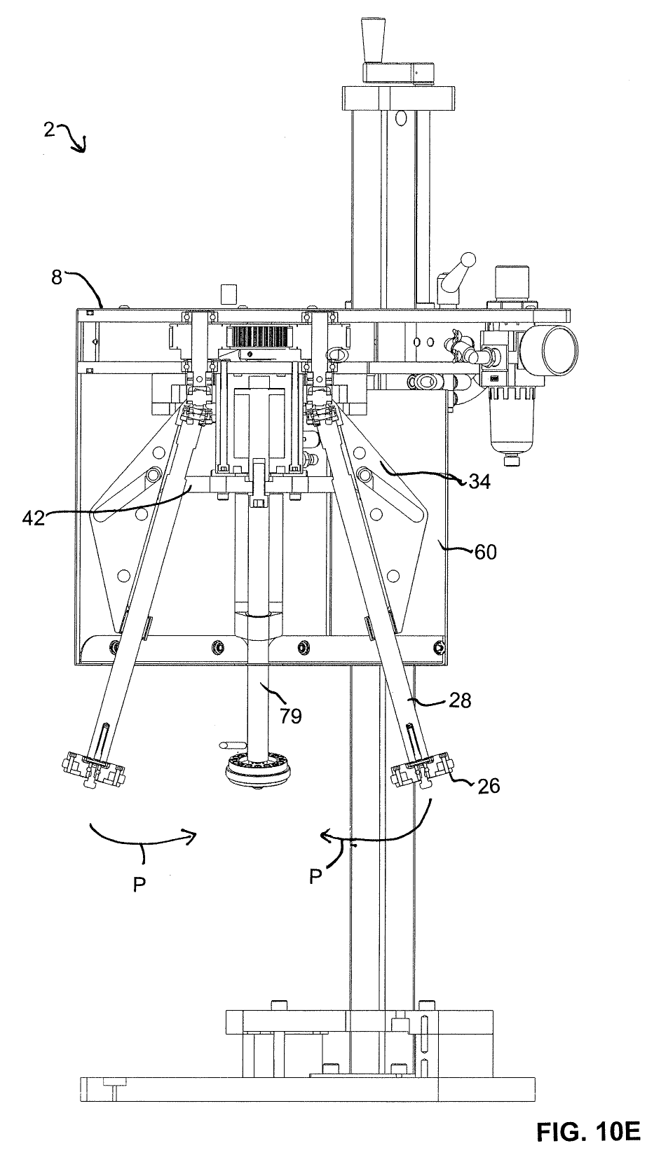

It is to be appreciated that the guide assembly pivots 32 and the associated drive shaft pivots 40, or constant velocity knuckles or other pivotable joints, permit each one of respective pivotable arms 28, e.g., the drive shaft 38 and the guide assembly 34, to pivot along a confined predetermined arcuate path P (see FIGS. 10A, 11A and 12A, for example) and thereby pivot or otherwise move the pivotable arms 28 from a disengaged first position into an engaged second position, and vice versa. It is to be appreciated that such pivoting motion, of the pivotable arms 28, somewhat resembles the pivoting motion of rigid arms of a conventional umbrella during opening and closing of the umbrella.

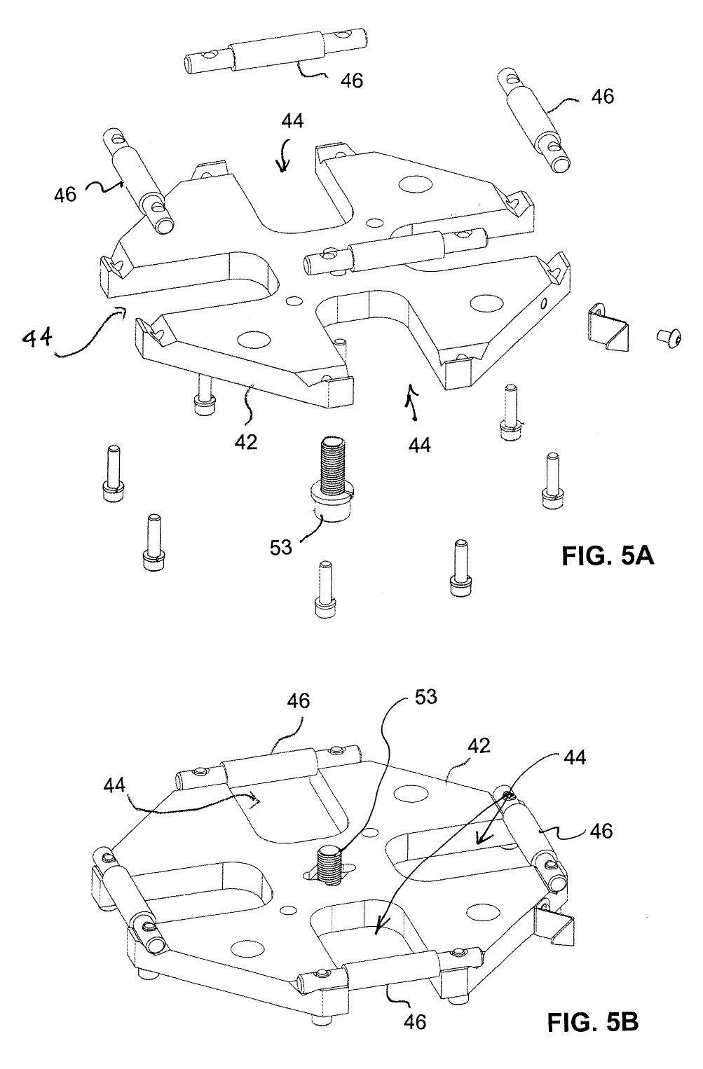

With reference now to FIGS. 5A and 5B, a discussion concerning the purpose and function of a central constrictor plate 42, which is coupled to each one of the guide assemblies 34 of the pivotable arms 28, as well as movement of the constrictor plate 42, for controlling actuation of the pivotable arms 28, will now be provided. As shown, the constrictor plate 42 has four spaced apart cut out areas or recesses 44 formed therein. Each one of the cut out areas or recesses 44 accommodates one of the guide assemblies 34 therein. A respective roller 46 extends completely across each one of the cut out areas or recesses 44 and through the slot 36 of the respective guide assembly 34 accommodated within the respective cut out area or recess 44 while the opposed ends of each roller 46 are secured to the constrictor plate 42 in a conventional manner, e.g., by conventional fasteners for example. As a result of such arrangement, each one of the guide assembly 34 and thus the pivotable arms 28 are, in turn, coupled to the constrictor plate 42 so as to facilitate actuation thereof as a result of any vertical movement of the constrictor plate 42 relative to the main support 8. That is, as the constrictor plate 42 is vertically manipulated, as will be described below in further detail, the rollers 46 are able to freely roll along either one of the opposed inwardly facing surfaces of the inclined slots 36 of the associated guide assemblies 34 and thereby induce a desired corresponding movement of the pivotable arms 28.

A vertically lower first end of a plate piston shaft 48, of a constrictor plate cylinder 52, is connected to a central region of the constrictor plate 42, e.g., by a bolt or a screw 53 extending through a central opening of the constrictor plate 42 (see FIG. 5B for example), while an opposite end of the plate piston shaft 48 is connected to or formed integral with a pneumatic constrictor plate piston 50 (see FIGS. 10E and 11E, for example), which is accommodated within and movable relative to the constrictor plate cylinder 52. The constrictor plate cylinder 52 is fixedly connected with and integrally supported by the main support 8. As result of such arrangement, as the constrictor plate piston 50 is conveyed to and fro, within the constrictor plate cylinder 52, the constrictor plate piston 50, in turn, correspondingly induces vertical upward or vertical downward movement of the constrictor plate 42, relative to the main support 8, via the plate piston shaft 48 interconnected therebetween. Such movement of the constrictor plate 42, in turn, causes pivoting movement of the associated guide assemblies 34 and thus the pivotable arms 28, about their respective pivots 32, 40, relative to the main support 8, so that the free remote ends of the pivotable arms 28 move along their desired arcuate paths P.

The cap engagement mechanism generally comprises the constrictor plate cylinder 52, the plate piston shaft 48, the constrictor plate 42 and the pivotable arms 28.

It is to be appreciated that other implementations of this concept could utilize, for example, linkages with pivots, more closely resembling arms of an umbrella in order to cause the free ends of the pivotable arms 28 move along their desired arcuate paths or some other related or similar path of the pivotable arms 28, e.g., radial. For example, other arrangements may also include linear constricting devices arranged in a radial fashion, such as linear slides, linear cam actuation, rotary cam actuation, spiral cam actuation or other conventional methods or mechanisms for attaining generally radially inward and/or radially outward movement. The important aspect is that at least one of the wheels 26 generally moves away from the at least one other wheel, in a disengaging first direction, while also having the ability of the at least one wheel to move toward at least one other wheel, in an engaging second direction.

A second portion of the drive shaft pivot 40, or the constant velocity knuckle or pivotable joint, is connected to a respective slave pulley 54′ (see FIG. 4C, for example) for supplying rotational drive to the drive shaft 38 and, in turn, the rotatable wheel 26 supported by the free end of each of the pivotable arms 28. As shown in FIG. 9, the drive mechanism includes a flexible drive belt 56 which is sufficiently tensioned by at least one or possibly a pair of idler pulleys 58, in a conventional manner, and driven via a master pulley 54 which is supported by a drive shaft of a fluid or air motor 60. The flexible drive belt 56 wraps sufficiently around the master pulley 54 and at least partially wraps around each one of the four (4) slave pulleys 54′ to facilitate supplying rotational drive thereto during operation of the pneumatic motor 60, discussed below in further detail. When the fluid or air motor 60 is operated, the master pulley 54 is rotationally driven which, in turn, drives the flexible drive belt 56. The flexible drive belt 56, in turn, rotates and drives each one of the respective slave pulleys 54′ and the associated drive shaft pivots 40, or constant velocity knuckles or pivotable joints, and, in turn, the associated drive shaft 38 and the rotatable wheel 26 supported at the free ends of the pivotable arms 28 to facilitate desired capping/uncapping of the desired cap 24 with the desired container 22.

A pulley engaging drive surface of the flexible drive belt 56 may be provided with gripping teeth or grooves. The master pulley 54 and each one of slave pulleys 54′ typically each have a grooved exterior surface (see FIG. 4C) which is designed to mate with the associated teeth or grooves of driving surface of the flexible drive belt 56 so as to avoid any relative slippage between the master pulley 54 and/or the slave pulleys 54′ and the flexible drive belt 56 during rotation of the drive belt 56. Other conventional and well known drive arrangements may be substituted in place thereof without departing from the spirit and scope of the present invention.

As shown in FIGS. 1-3 for example, a majority of the internal components of the cap securing apparatus 2, discussed above, are enclosed and housed within an exterior housing 62 which includes a top panel 64, three or possibly four side panels 66 and a bottom panel 68. It is to be appreciated that one or more of the panels may be formed integrally with one another, e.g., three of the side panels, or each panel may be completely independent of one another. Each one of the panels 64, 66, 68 is generally secured to the main support 8 by one or more fasteners or otherwise attached in a conventional manner. The bottom panel 68 has four elongate arm slots 70 formed therein and each one of the arm slots 70 receives the drive shaft 38 (see FIGS. 10C, 11C and 12C), of a respective one of the pivotable arms 28, to project therethrough and move to and fro along the arcuate path of the pivotable arm 28, in a substantially unhindered manner, from its fully disengaged first position to its fully engaged second position, and vice versa.

Operation of the cap securing apparatus 2 generally occurs as follows. An operator will first adjust the relative spacing position or engagement height S between the wheels 26, supported by the main support 8, and the support base 4 of the cap securing apparatus 2, in the event that such vertical adjustment is necessary. Assuming that a vertical lowering adjustment is required, the operator first places the container 22 with a cap 24 to be secured/unsecured thereto on the support base 4 and then loosens the post clamp 20 and rotates the elevation lead screw crank 18 in a desired rotational direction, such as the counterclockwise direction, which lowers the main support 8 along the guidepost 10 and, in turn, the wheels 26 supported by the pivotable arms 28, until the wheels 26 are located so as to sufficiently and suitably engage with the lateral surface 30 of the cap 24 to be capped/uncapped, e.g., the wheels 26 will preferably engage with an intermediate portion of the lateral surface 30, e.g., between a lower most peripheral edge and an upper most peripheral edge, of the cap 24 to be capped/uncapped. Once the cap securing apparatus 2 is suitably adjusted, rotation of the elevation lead screw crank 18 is discontinued and the post clamp 20 is then re-tightened to lock the adjusted position of the main support 8 relative to the post-assembly 6 and the support base 4.

In the event that a vertically taller container is to be capped/uncapped, the operator loosens the post clamp 20 and then rotates the elevation lead screw crank 18 in a desired rotational direction, such as the clockwise direction, to sufficiently raise the relative position of the wheels 26, supported by the main support 8, so that the operator can then place the container 22 with the cap 24 to be capped/uncapped onto the support base 4. Once the container 22 with the cap 24 to be capped/uncapped can be placed upon the support base 4, then the operator rotates the elevation lead screw crank 18, in either a clockwise or a counter clockwise direction, to provide any desired fine tuning adjustment so that the wheels 26 will sufficiently and suitably engage with the lateral surface 30 of the cap 24 to be capped/uncapped, e.g., the wheels 26 will preferably engage with an intermediate portion of the lateral surface 30 of the cap 24. Once the cap securing apparatus 2 is suitably adjusted, the post clamp 20 is then re-tightened to lock the main support 8 in the adjusted position relative to the guidepost 10 of the post-assembly 6 and the support base 4 and prevent any undesired relative movement therebetween.

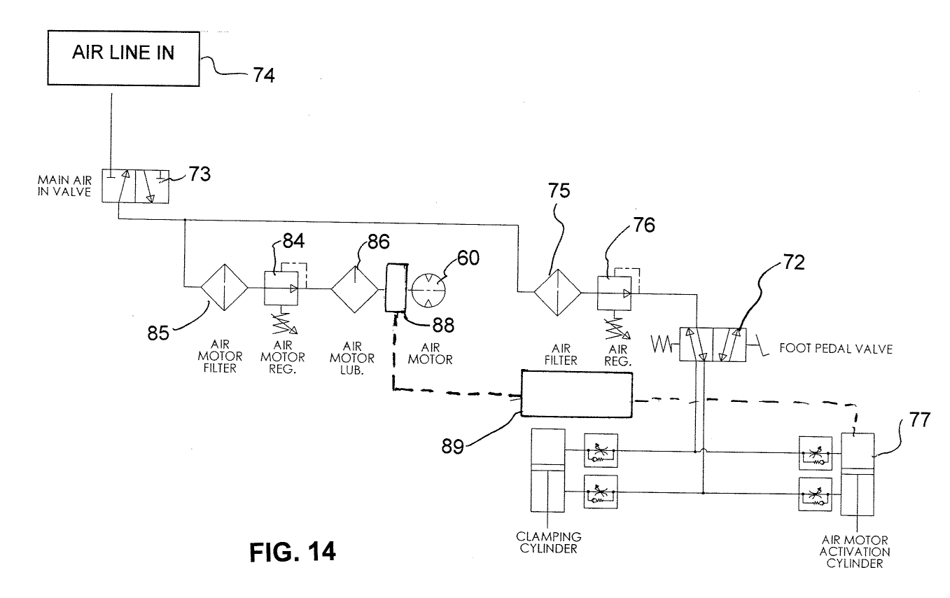

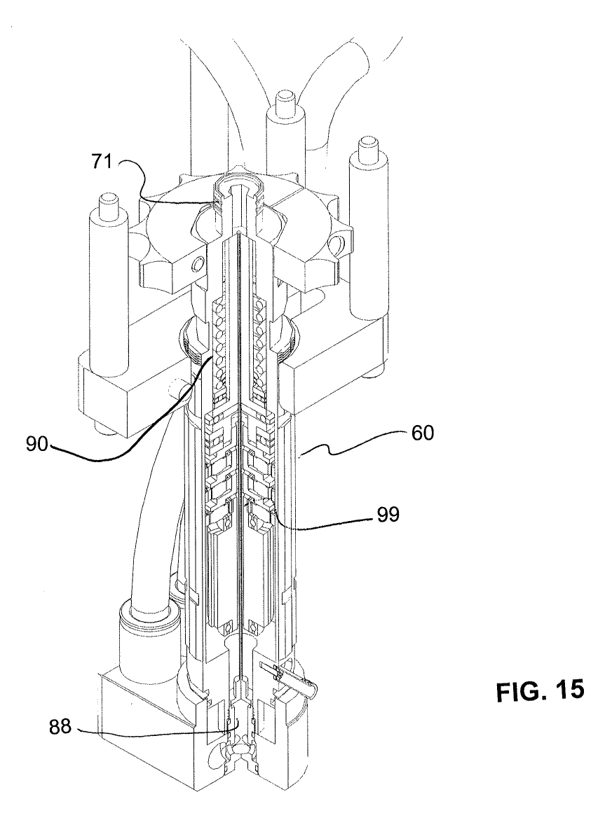

As shown in FIGS. 1 and 14, a pressurized air or fluid actuator 72, such as a foot pedal which is typically biased into an undepressed position, is coupled in a conventional manner to a conventional source of compressed or pressurized air or fluid 74, for example, to facilitate desired actuation of the cap securing apparatus 2 by an operator. It is to be appreciated that a variety of conventional actuating mechanisms may be substituted or utilized in place of the shown foot pedal pressurized air or fluid actuator. For example, a handheld actuating lever or a dual palm actuating lever (e.g., a lever which requires both hands of the operator to be simultaneously grasping two locations of the dual palm actuator in order to actuate lever and thereby ensure that both hands of the operator are clear of the pivotable arms 28 so as to prevent inadvertent injury thereto) may be utilized, without departing from the spirit and scope of the present invention.

It is to be appreciated that the cap securing apparatus 2, according to the present invention, may be substantially automated. That is, the pressurized air or fluid actuator 72 may comprise some type of conventional sensor, switch, button, actuator, sensor, detector, etc., which either detects or senses the presence of a bottle or a container 22 on the support base 4 or resting against the V-block 27 and, upon detecting or sensing the bottle or container 22 on the support base 4 or against the V-block 27, automatically triggers actuation and cycling of the cap securing apparatus 2. Alternatively, a button, a switch or an actuator may be located on either the support base 4 or against the V-block 27 and such button, switch or actuator will be automatically actuated or depressed upon the operator placing the bottle or container 22 on the support base 4 or against the V-block 27 thereby automatically triggering actuation and cycling of the cap securing apparatus 2.

A main valve 73 controls the flow of the pressurized air or fluid from the source of compressed or pressurized air or fluid 74 to the cap securing apparatus 2. After passing through the main valve 73, the pressurized air or fluid branches into two flow paths, i.e., a first flow path flows to the pressurized air or fluid actuator 72 while a second flow path flows to the air motor 60.

The pressurized air or fluid actuator 72, in the event that it is a foot pedal, may be located on the floor or on some other desired surface, typically for actuation or depression by the foot of the operator. In the spring biased non-depressed state shown in FIGS. 1, 2 and 14, the pressurized air or fluid actuator 72 is coupled to supply compressed or pressurized air or fluid to a first, lower most end of the constrictor plate cylinder 52. An air or fluid first regulator 76 is typically located along the supply line, typically between the main valve 73 and the pressurized air or fluid actuator 72 so as to facilitate adjustment of the pressure of the pressurized air or fluid to be supplied to the constrictor plate cylinder 52. A first adjustable knob 80, of the air or fluid first regulator 76, facilitates adjustment of the supply pressure of the pressurized air or fluid. In addition, an air or fluid filter 75 may also be provided between the main valve 73 and the pressurized air or fluid actuator 72. In many applications, the pressurized air or fluid is supplied at a pressure of about 90 PSI. It is to be appreciated, however, that the supply pressure may vary from application to application depending upon the gripping force to be provided by the wheels 26.

When the main valve 73 is opened and the pressurized air or fluid actuator 72 remains unactuated, the pressurized air or fluid actuator 72 typically supplies the pressurized air or fluid to an air motor activation cylinder 77 which deactivates and maintains the air motor activation cylinder 77 in a vertically lower most position which, in turn, avoids activation of the air motor 60. As diagrammatically shown, the pressurized air or fluid actuator 72 also supplies the pressurized air or fluid from the pressurized air or fluid actuator 72 to the lower most first portion of the constrictor plate cylinder 52 so as to drive the constrictor plate piston 50 in a vertically upward direction, away from the support base 4, and into its vertically uppermost position within the constrictor plate cylinder 52, as shown in FIG. 10E. Such motion of the constrictor plate piston 50, in turn, causes the constrictor plate 42 to also be simultaneously moved vertically upward toward its vertically upper most position and away from the support base 4 and, in turn, simultaneously causes each one of the pivotable arms 28 to all be simultaneously biased radially outward, along their arcuate paths, away from one another and away from the cap 24 and/or container 22 supported by the support base 4. That is, each one of the pivotable arms 28 is biased in a generally radially inward direction into the disengaged first position, as generally shown in FIGS. 10A-10E.

Adjustment of the first adjustable knob 80, of the air or fluid first regulator 76, in a first direction, increases the supply pressure of the compressed air or fluid which supplied to the constrictor plate cylinder 52, as well as the air motor activation cylinder 77, and thereby increases the clamping force that the constrictor plate 42 and, in turn, the pivotable arms 28 and the wheels 26 can exert on the cap 24 to be capped to or uncapped from the container 22 while adjustment of the air or fluid first regulator 76, in the opposite direction, decreases the supply pressure of the compressed air or fluid which supplied to the constrictor plate cylinder 52 and the air motor activation cylinder 77 and thereby decreases the clamping force that the constrictor plate 42 and the wheels 26 can exert on the cap 24 to be capped to or uncapped from the container 22.

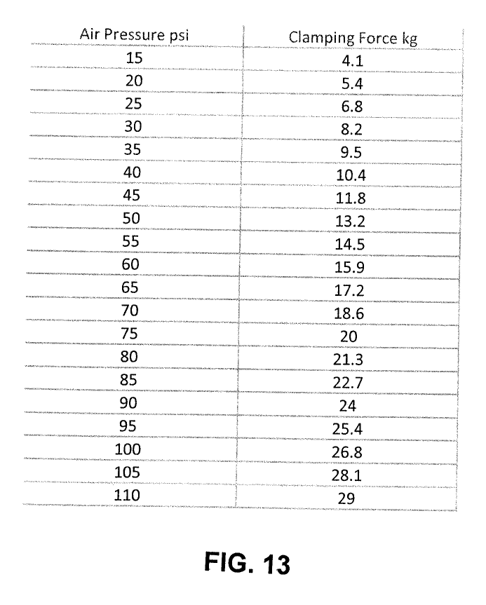

As shown in FIG. 13, typical clamping forces to be achieved by the plurality of wheels 26, against the cap 24, depend upon the supply pressure of the compressed air or fluid. It is to be appreciated that the clamping force should be set sufficiently high so as to avoid any slippage occurring between the rotating wheels 26 and the cap 24 to be capped or uncapped, but not be excessive so as to cause any significant distortion of the cap 24 to be capped or uncapped and thereby cause undesired drag between mating threads of the container 22 and the cap 24. It is to be appreciated that the clamping force, generated by the cap securing apparatus 2, is directly proportional to the air pressure setting of the air or fluid first regulator 76.

As mentioned above, the pressurized air or fluid also flows along the second flow path to the air motor 60. An air or fluid regulator 84 is located along the supply line, typically between the main valve 73 and the air motor 60 so as to facilitate adjustment of the supply pressure of the pressurized air or fluid to be supplied to the air motor 60. A second adjustable knob 94, of the air or fluid second regulator 84, facilitates adjustment of the supply pressure of the pressurized air or fluid. In addition, an air or motor filter 85 and/or an air motor lubricator 86 may also be provided along the supply path between the main valve 73 and the air motor 60.

When the operator actuates or depresses the pressurized air or fluid actuator 72, the supply of the compressed or pressurized air or fluid thus flows to the upper most second portion of the constrictor plate cylinder 52 while the first portion of the constrictor plate cylinder 52 may be vented to atmosphere in order to facilitate venting and/or relieving any residual pressure contained therein. The compressed or pressurized air or fluid supply to the second end of the constrictor plate cylinder 52, in turn, drives the constrictor plate piston 50 in a vertically downward direction toward the support base 4 and toward the opposite end of the constrictor plate cylinder 52. Such motion of the constrictor plate piston 50 also simultaneously causes the constrictor plate 42 to move simultaneously vertically downward toward the support base 4 and, in turn, simultaneously causes each one of the pivotable arms 28 to be simultaneously drawn radially inward, along their respective arcuate paths, toward one another and toward any centrally located cap 24 to be capped/uncapped relative to the container 22. That is, the rollers 46 move vertically downward along with the constrictor plate 42 and roll along the inwardly facing surfaces of the inclined slots 36 of the associated guide assemblies 34 and thereby draw the associated guides assemblies 34 radially inward toward one another and induce a corresponding movement of the pivotable arms 28 generally radially inwardly, along their respective arcuate paths, into their engaged positions with the cap 24, as generally shown in FIGS. 12A-12E.

At the same time that operator actuates or depresses the pressurized air or fluid actuator 72, the pressurized air or fluid also flows to opposite end of the air motor activation cylinder 77 which, in turn, initiates temporary activation of the air motor 60. The air motor activation cylinder 77 actuates the air motor 60 by forcing one end of the lever 89 located adjacent a top portion of the air motor 60 so that the opposite end of the lever 89 biases or pushes the drive shaft 71, e.g., a 1/4″ hex shaft using an arrangement of thrust washers and pins, essentially creating a throw-out bearing (not shown in detail), of the air motor 60 vertically downward. The hex shaft is a ball spline and, as is well known in the art, a ball spline is a specialized shaft that transmits torque but allows low friction axial movement. Such downward motion of the drive shaft 71 also simultaneously biases a long slender activation rod 99 through a center of the air motor 60 and toward the opposed bottom end the air motor 60. Such movement of the activation rod 99, in turn, opens a valve 88 located within the bottom of the air motor 60 which permits the compressed or pressurized air or fluid to flow into the vane type air motor 60. The compressed or pressurized air or fluid causes the vane type air motor 60 to rotate in a desired rotational direction and at a desired rotational speed thereby turning the three sets of planetary gears (not labeled) and generating the desired rotational drive.

As soon as a preset torque is reached, the balls within a clutch roll or along a ramp thereby compressing a preload spring. Such vertical motion within the clutch mechanism 90 lifts the activation rod 99 and forces the activation rod 99 vertically upward toward a vertically upper portion of the air motor 60. This, in turn, also causes the valve 88, located within the base of the air motor 60, to close and thereby interrupt the flow of compressed or pressurized air or fluid to the air motor 60 and causes rotation of the air motor 60 to discontinue and the drive shaft 71 is again correctly positioned for another cycle. The air motor 60 typically only operates at the desired rotational speed and in the desired rotational direction for a short duration of time, typically less between about 0.5 seconds to about two seconds or so.

The system is typically provided with a selector valve that diverts the supplied compressed or pressurized air or fluid to one side or the other of the air motor 60 so as to facilitate creating either a clockwise or a counter clockwise rotation of the air motor. In addition, a desired tightening torque of the air motor 60 can be adjusted by varying a spring preload on the clutch mechanism, using the large grooved wheel at the top of the air motor 60.

The hex shaped output, which is attached to the drive shaft 71 of the air motor 60, has three semi-circular grooves cut into it to accept a row of steel balls. A hollow pulley shaft, which is coaxial with the drive shaft 71 of the air motor 60, also has three matching or mating semi-circular grooves. The balls make contact between these grooves and transmit the torque, while the grooves allow the balls and hex shaft to move easily along the axis of rotation.

As noted above, the drive air shaft 71 of the air motor 60 is coupled to and drives the master drive pulley 54 which, in turn, is directly connected with the flexible drive belt 56 so as to supply rotational drive to the flexible drive belt 56 and, in turn, to each one of the four slave pulleys 54′ engaged with the flexible belt 56. Consequently, the flexible drive belt 56 can simultaneously drive each of the slave pulleys 54′ at the same rotational speed upon rotation of the drive belt 56.

As also described above, each respective slave pulley 54′, in turn, rotates a respective drive shaft 38 and the wheel 26 supported adjacent the free end thereof, via the drive shaft pivot 40, e.g., the constant velocity knuckle or pivotable joint. Each one of the rotating wheels 26 then engages with the outwardly facing lateral surface 30 of the cap 24 and thereby induces desired rotation of the cap 24 for capped/uncapped the cap 24 with respect to the container 22.

It is to be appreciated that if the wheels 26 are rotated in a first rotational direction, the wheels 26 can be utilized for capping, tightening, torquing or securing the cap 24 to the container 22. Alternatively, if the wheels 26 are rotated in a second opposite rotational direction, the wheels 26 can be utilized to facilitate uncapping, loosening, untorquing unsecuring the cap 24 from the container 22. During such rotation of the cap 24 relative to the container 22, the operator may hold the container 22, if desired or necessary, to prevent rotation of the container 22 relative to the support base 4 as the cap 24 is capped/uncapped, or use a vise or V-block 27/lateral guides 29 arrangement as discussed above.

Once the cap 24 is sufficiently capped/uncapped with respect to the threaded opening of the container 22, the operator then removes his/her foot, thumb(s) or finger(s) from the pressured air or fluid actuator 72. As the pressured air or fluid actuator 72 returns back to its fully extended undepressed position, the compressed or pressurized or air or fluid from the pressured air or fluid actuator 72 is then again supplied to the first portion end of the constrictor plate cylinder 52. Such supply of compressed or pressurized or air or fluid to the first portion of the constrictor plate cylinder 52, in turn, biases and returns the constrictor plate piston 50, connected to the constrictor plate 42, vertically upward away from the support base 4, thereby causing the pivotable arms 28 to pivot substantially radially outward, along their respective arcuate paths, from their engaged second position, shown in FIGS. 12A-12E, away from the cap 24 just capped to, or possibly uncapped from, the container 22 into their respective disengaged first position, shown in FIGS. 10A-10E.

In addition, at the same time, the supply of the compressed or pressured air or fluid to the air motor activation cylinder 77 is also supplied to the opposite end of the activation cylinder 77 so as to avoid activation of the air motor 60. As described above, it is to be appreciated that rotation of the wheels 26, for capping/uncapping the cap 24, is automatically terminated after a short duration of time following actuation of the compressed air or fluid actuator 72, e.g., only a few seconds, regardless of whether or not the compressed air or fluid actuator 72 still remains depressed.

With reference now to FIGS. 10A-10E, the initial starting, disengaged first position of the pivotable arms 28, prior to actuation of the compressed air or fluid actuator 72, is shown where each one of the pivotable arms 28 is located in its fully expanded and disengaged first position. Upon actuation of the pressurized air or fluid actuator 72, each one of the pivotable arms 28 simultaneously commences movement along its respective arcuate path P (generally indicated by curved arrows in those Figures) toward the cap 24 to be capped/uncapped with respect to the container 22. Such movement is induced by corresponding movement of the constrictor plate 44, as described above.

FIGS. 11A-11E each show an intermediate position of the four (4) pivotable arms 28, e.g., generally located in an intermediate position between the completely disengaged first position of FIGS. 10A-10E and the fully engaged second position of FIGS. 12A-12E, and the plate piston 50 is generally located at a central position within the constrictor plate cylinder 52 between its two opposed end positions.

Once the constrictor plate 42 is biased into and reaches its vertically lowermost or end position, each one of the pivotable arms 28 is moved into its fully engaged second position with the cap 24, as shown in FIGS. 12A-12E. That is, such motion causes the wheels 26, supported by the lower free ends of each of the pivotable arms 28, to engage sufficiently with the lateral surface 30 of the cap 24 to be capped/uncapped with respect to the container 22 and transfer such rotation of the wheel(s) 26 to the cap 24 and thereby induces a securing/unsecuring rotation of the cap 24 with respect to the container 22.

Such radially inward movement of the pivotable arms 28 also assists with any desired or necessary minor centering or repositioning of the cap 24, between each one of the plurality of wheels 26, as the cap 24 is threadedly capped to or threadedly uncapped from the container 22 and such centering or repositioning of the cap 24 compensates for any initial small misalignment of the container 22 on the support base 4 relative to the wheels 26.

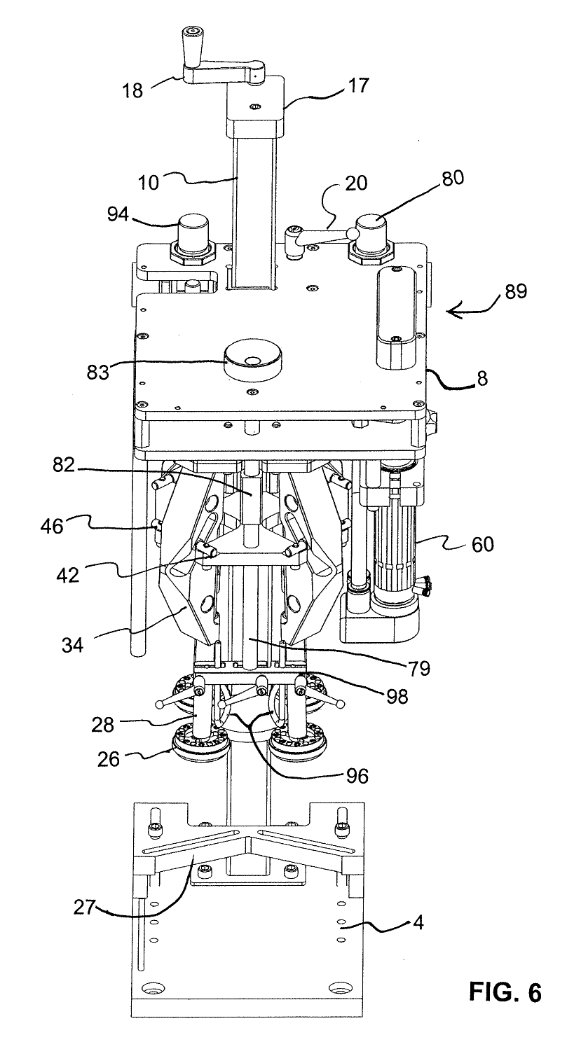

It is to be appreciated that the length of stroke of each one of the pivotable arms 28 can be adjusted by adjustment of a movable stop 82 (see FIGS. 6 and 7. The movable stop 82 is slidably adjustable along a guide rod 79 which is supported by the main support 8. A control knob 83 is connected with a threaded rod 85 to facilitate rotation thereof and a lower end of the threaded rod 85 threadedly engages with the movable stop 82. As a result of such arrangement, rotation of the control knob 83 in a first rotational (e.g., clockwise) direction draws or moves the movable stop 82 vertically upward, along the guide rod 79, away from the constriction plate 42 and toward the main support 8 while rotation of the control knob 83 in an opposite second rotational (e.g., counterclockwise) direction pushes or moves the movable stop 82 vertically downward, along the guide rod 79, toward the constriction plate 42 and away from the main support 8. It is to be apparent that the constrictor plate 42, when moving toward its vertically upper first position, will typically abut against the movable stop 82 so as to thereby prevent further “opening” of disengaging movement of the constrictor plate 42 and, in turn, prevent further “opening” of disengaging movement of the pivotable arms 28. Adjustment of the movable stop 82 thereby controls the maximum range of movement that the pivotable arms 28, supporting the wheels 26, are permitted to travel when moving from their engaged second position, shown in FIGS. 12A-12E, into their disengaged first position, shown in FIGS. 10A-10E, during the vertical upward movement of the constrictor plate 42. That is, the maximum distance the pivotable arms 28 are allowed to move radially outward, along their respective arcuate paths away from one another, can be readily controlled and adjusted by the operator to suit any particular application. By permitting adjustment of the range of movement of the pivotable arms 28, between the engaged position and the disengaged position, this facilitates a quicker and more rapid cycle time for the cap securing apparatus 2 and also avoids any excess or unnecessary engaging and disengaging motion, thereby decreasing the cycle time for the cap securing apparatus 2 to either engage with or disengage from the cap 24.

The range of motion of the wheels 26 can be adjusted by merely observing an indicator on the front of the cap securing apparatus 2 (not shown). This indicator typically has two scales and a first scale, e.g., the left scale, is calibrated for smaller wheels (e.g., wheels which have a diameter of approximately 25 mm, for example), while the second scale, e.g., the right scale, is calibrated for larger wheel assemblies (e.g., wheel assemblies which have a diameter of approximately 50 mm, for example). If desired, a third scale may be provided for intermediate wheels (e.g., wheel assemblies which have a diameter of approximately 37.5 mm, for example).

Another feature of the cap securing apparatus 2 is a quick releasable lock 91, as shown in FIG. 4D, that secures each one of the wheels 26 to the pivotable arms 28 while allowing the wheels 26 to quickly and easily removed from the pivotable arms 28 thereby to facilitate changing/replacement of the wheels 26 supported by the remote free end of the pivotable arms 28. When changing or replacement of one or more wheels 26 is desired, a spring loaded button 92, located on the remote free end of the pivotable arm 28, is depressed axially inward and such depression partially retracts one or more locking balls 93 out of engagement with an internal annular groove formed on an inwardly facing hub of the wheel 26 so that the wheel 26 can then be easily slid off a cylindrical area of the drive shaft 38 and removed from the remote free end of the pivotable arm 28 and replaced with a new larger diameter wheel, a new smaller diameter wheel or a same diameter new replacement wheel 26, in the event that the previous wheel 26 becomes sufficiently worn or otherwise requires servicing and/or replacement.

Following placement of a new wheel 26 on the cylindrical surface of the drive shaft 38, the spring loaded button 92 is then release and the radially inwardly partially retracted locking ball(s) 93 are then biased radially outwardly so as to seat against an internal annular groove formed on an inwardly facing hub of the wheel 26 and thereby lock the wheel 26 to the remote free end of the pivotable arm 28. The function of the ball(s) 93 is similar to that of a locking ball commonly found on a square drive ratchet. This arrangement facilitates rapid replacement and/or changeover from one wheel 26 to another so that the cap securing apparatus 2 can quickly and easily be modified or adapted to accommodate caps 24 having different shapes and sizes and/or having a wide array of different auxiliary features or components such as a pump, a spray button, etc. It is to be appreciated that the larger diameter wheels 26 are generally used when the cap 24 to be secured includes a large spray head, a pump spout, or some other protruding feature(s) or component(s) which may contact or otherwise interfere with the desired operation of the pivotable arms 28. The larger diameter wheels 26 assist with adequately spacing the pivotable arms 28 from any protruding spray head, pump spout, or other feature(s) or component(s) of the cap 24 so that such protruding spray head, pump spout, or other feature(s) or component(s) do not hinder or obstruction reliable securing of the cap 24 to the container 22.

The cap securing apparatus 2 may be provided with a convenient wheel storage post (not shown), located adjacent a rear section of the support base 4 of the cap securing apparatus 2, for temporarily storing an adequate supply of wheels 26 that are not currently being used and/or storing an adequate supply of replacement wheels 26. Such wheel storage post also facilitates rapid replacement of the wheels 26 once they become sufficiently worn, distorted or otherwise require repair or replacement. The unused or extra wheels 26 are merely stacked, one on top of the other, on the wheel storage post until the wheels 26 are otherwise needed or required.

A pair of adjustable guide arms 96 are adjustably supported by a bracket 98 which is adjustably connected to and along the guide rod 79 of the main support 8 (see FIGS. 6 and 7 for example). The bracket 98 is adjustable vertically along the length of the guide rod 79 in a conventional manner, e.g., by a setscrew, an adjustable fastener, etc., while a releasably clamped orientation of each one of the adjustable guide arms 96, with respect to the bracket 98 is also adjustable by a setscrew, an adjustable fastener, etc., to assist with properly aligning or orientating the nozzle, the spray head, the pump spout, or any other protruding feature of cap 24, so that such feature does not hinder the desired operational movement of the pivotable arms 28 and thereby increase the throughput of the cap securing apparatus 2 while also maintaining consistency. That is, the pair of adjustable guide arms 96 help rotate or otherwise properly align or position the nozzle, the spray head, the pump spout, or any other protruding feature of cap 24, when inserting on placing the container 22 and the cap 24 to be secured/unsecured and thereby decreases the need to pre-align the nozzle, the spray head, the pump spout, or any other protruding feature of cap 24 prior to placement on the support base 4.

It is to be appreciated that the cap securing apparatus 2 as well as the various motors and/or cylinders of the cap securing apparatus 2 may alternatively be driven by one or more electric motor(s) and associated gearing, one or more pneumatic motor(s) and cylinders, one or more hydraulic motor(s) and cylinder(s), manual levers and/or various combinations thereof, without departing from the spirit and scope of the present invention.

As discussed above, the support base 4 of the securing apparatus 2 may include a vice or some other conventional clamping mechanism which facilitates securing the desired container 22 to the support base 4 in a secure but releasable manner so as to prevent or minimize, at the very least, rotation of the container 22 while the cap 24 is either being secured thereto or uncapped therefrom. Such clamping mechanism provides further utility and safety when an operator utilizes the cap securing apparatus 2 according to the present invention.

In the above description and appended drawings, it is to be appreciated that only the terms “consisting of” and “consisting only of” are to be construed in the limitative sense while all other terms are to be construed as being open-ended and given the broadest possible meaning.

The terms “cap” and “container,” as used above and within the appended claims, are intended to be both given the broadest interpretation and meaning possible. This is, although the present invention is generally described, throughout this patent application, as being suitable for capping or uncapping a conventional cap with respect to a conventional bottle or a container, it is to be appreciated that the present invention has a variety of other applications. For example, the present invention would also be useful with respect to providing rotation of a first component (e.g., a cap, fastener, etc.), in a desired rotational direction, relative to a stationary second component (e.g., a container, a bottle, a surface, etc.). or example, the present invention may be utilized for driving a screw, or some other desired fastener, either into or out of a desired second stationary surface.

Since certain changes may be made in the above described cap securing apparatus, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A cap securing apparatus for rotating a cap relative to a container, the cap securing apparatus comprising:
a support base supporting a main support;
the main support supporting a plurality of arms, and each of the plurality of arms supporting a rotatable wheel adjacent a remote free end thereof;
a drive mechanism for supplying drive to at least one of the rotatable wheels, supported by the plurality of arms, for inducing rotation thereof;
a cap engagement mechanism for moving the wheels from a disengaged first position, in which the wheels are spaced from the cap to be one of capped or uncapped with respect to the container, into an engaged second position in which the wheels engage with the cap for inducing rotation of the cap and one of capping the cap to the container and uncapping the cap from the container.

2. The cap securing apparatus according to claim 1, wherein the main support is adjustably supported relative to the support base, a first end of a post assembly is secured to the support base and the main support is adjustably supported by and movable along the post-assembly to facilitate adjustment of a relative spacing between the main support and the support base

3. The cap securing apparatus according to claim 2, wherein the post-assembly generally comprises both a guidepost and a lead screw, the guidepost and the lead screw are located adjacent to and extend parallel to one another, the guidepost engages with the main support so as to prevent rotation of the main support while a threaded section of the main support threadedly engages with the lead screw to facilitate conveyance of the main support one of vertically toward and vertically away from the support base.

4. The cap securing apparatus according to claim 2, wherein the cap securing apparatus further includes a post clamp for retaining an adjusted vertical position of the main support, along the post-assembly relative to the support base, following adjustment thereof.

5. The cap securing apparatus according to claim 1, wherein the plurality of pivotable arms comprise at least four pivotable arms and each one of the pivotable arms comprises a guide assembly and a rotatable drive shaft which supports the rotatable wheel, a vertically upper end of each one of the pivotable arms is pivotally connected to the main support and the drive shaft is connected to the drive mechanism, via a pivot joint, for supplying drive to the rotatable wheels supported by each one of the four pivotable arms.

6. The cap securing apparatus according to claim 5, wherein the cap engagement mechanism comprises a constructor plate cylinder coupled to a constrictor plate, and each guide assembly has an elongate slot and a respective roller engages with the elongate slot and couples each one of the guide assemblies to the constrictor plate to facilitate controlling movement thereof.

7. The cap securing apparatus according to claim 6, wherein a constrictor plate shaft interconnects a constrictor plate piston, of the constructor plate cylinder, with the constrictor plate for moving the constrictor plate away from the main support and thereby pivoting the pivotable arms into the engaged second position, and moving the constrictor plate toward the main support and thereby pivoting the pivotable arms into the disengaged first position.

8. The cap securing apparatus according to claim 5, wherein each guide assembly has a cylindrical sleeve which receives and surrounds an intermediate portion of the respective rotatable drive shaft so as to control movement of the rotatable drive shaft.

9. The cap securing apparatus according to claim 5, wherein each guide assembly is pivotally connected to the main support via an assembly pivot and each drive shaft is pivotally connected to the drive mechanism via a constant velocity joint.

10. The cap securing apparatus according to claim 5, wherein the drive mechanism comprises a master pulley supported by a drive shaft of a motor, a flexible drive belt wraps around the master pulley and at least partially wraps around a plurality of slave pulleys to facilitate supplying rotational drive to the slave pulleys upon operation of the motor, and each slave pulleys is coupled to a respective drive shaft via a pivot joint to facilitate rotating the respective drive shaft.

11. The cap securing apparatus according to claim 10, wherein a surface of the drive belt has gripping teeth and the master pulley and the slave pulleys each have a mating exterior surface so as to minimize relative slippage therebetween.

12. The cap securing apparatus according to claim 1, wherein the support base includes a vice which facilitates securing the container to the support base to prevent rotation of the container with respect to the support base.

13. The cap securing apparatus according to claim 1, wherein the support base supports an adjustable V-block which assists with consistent positioning of the container relative to the support base.

14. The cap securing apparatus according to claim 13, wherein the V-block is adjustably supported by a top surface of the support base, and the V-block has at least a pair of adjustment slots which each adjustably support a lateral guide which facilitate adjusting a size of a receiving area for accommodating the container to prevent relative rotation of the container with respect to the support base.

15. The cap securing apparatus according to claim 12, wherein a first adjustable regulator facilitates controlling a supply pressure of air or fluid supplied to the constrictor plate cylinder to either increase a clamping force that the wheels can exert on the cap to be capped or uncapped from the container or decrease the clamping force that the wheels can exert on the cap to be capped to or uncapped from the container.

16. The cap securing apparatus according to claim 1, wherein a pressurized air or fluid actuator is coupled to a source of pressurized air or fluid which facilitates desired actuation of the cap securing apparatus by an operator, and first adjustable regulator permits adjustment of a clamping force to be exerted upon engagement of the wheels with the cap so as to avoid slippage between the wheels and the cap.

17. The cap securing apparatus according to claim 16, wherein the a pressurized air or fluid actuator is one of a foot pedal biased into an undepressed position, a handheld actuating lever biased into an undepressed position, and a dual palm actuating lever.

18. The cap securing apparatus according to claim 1, wherein a movable stop is provided for adjusting a length of a stroke of each one of the pivotable arms, the movable stop is slidably adjustable along a guide rod, and a control knob, connected with a threaded rod, facilitates adjustment of the movable stop.

19. The cap securing apparatus according to claim 18, wherein a pair of adjustable guide arms are adjustably supported by a bracket which is adjustably connected to the guide rod, and the adjustable guide arms assist with aligning any protruding feature of the cap so that such protruding feature does not hinder operational movement of the pivotable arms.

20. A method of rotating a cap with respect to a container via a cap securing apparatus for rotating a cap relative to a container, the cap securing apparatus comprising a support base supporting a main support, the main support supporting a plurality of arms, and each of the plurality of arms supporting a rotatable wheel adjacent a remote free end thereof, a drive mechanism for supplying drive to at least one of the rotatable wheels, supported by the plurality of arms, for inducing rotation thereof, a cap engagement mechanism for moving the wheels from a disengaged first position, in which the wheels are spaced from the cap to be one of capped or uncapped with respect to the container, into an engaged second position in which the wheels engage with the cap for inducing rotation of the cap and one of capping the cap to the container and uncapping the cap from the container, the method comprising the steps of:
placing the container with the cap to be one of capped to or uncapped from the container on the support base;
actuating the drive mechanism to supply drive to at least one of the rotatable wheels an actuation device;
actuating the cap engagement mechanism to move the wheels from the disengaged first position into the engaged second position to engage and induce rotation of the cap and one of capping the cap to the container and uncapping the cap from the container; and
deactuating both the drive mechanism and the cap engagement mechanism.
